(19) United States
(12) Patent Application Publication
(10) Pub. No.: US 2023/0279978 A1
(43) Pub. Date: Sep. 7, 2023

(54) High Pressure Conduit Connector and Safety Conduit System Including Same

(71) Applicant: Andrew Charles Abrams, Bryn Mawr, PA (US)

(72) Inventor: Andrew Charles Abrams, Bryn Mawr, PA (US)

(21) Appl. No.: 18/316,304

(22) Filed: May 12, 2023

Related U.S. Application Data
(63) Continuation-in-part of application No. 16/281,306, filed on Feb. 21, 2019.

(51) Int. Cl. F16L 33/24

(52) U.S. Cl. CPC F16L 33/24; F16L 2201/20

(57) ABSTRACT

Safety conduit system includes a pair of couplings, each including an elongate fitting or housing having barbs at one end and spaced apart teeth at an opposite end. A conduit made of a thermoplastic hose, and stainless steel reinforcement around the hose is attached at each end to the barbed end of a respective coupling. A thread is optionally provided on an outer surface of the housing inward of the barbs so that ferrules on the conduit and having inner threads can threadingly engage with the threads on the couplings and enable the safety conduit system to maintain connection between the conduit and couplings at relatively high fluid flow pressure through the safety conduit system, such as around 40,000 psi.

### FIELD OF THE INVENTION

The present invention technology relates to safety conduit system for a fluid delivery handling system and particularly to a coupling configured to withstand high-pressure fluids. The present invention relates specifically to a coupling through which fluids at high pressure, such as pressures above 10,000 psi flow, and which is configured to have a higher failure pressure than a hose with which the coupling is connected.

### BACKGROUND OF THE INVENTION

There are many instances where fluids are delivered at high pressure through a system of conduits. There is a significant risk associated with failure of such handling systems. Unintentional release of these fluids poses significant health risks as well as the risk of property damage. When a handling system fails, by rupturing or splitting, there are safety systems that can contain the discharge of liquids or gases. With the arrival of new conduits made of material especially designed for ultra high-pressure fluids exceeding 24,000 psi, there is a need for a safety conduit system that can function in that environment.

An additional need in the technology of high-pressure delivery systems is a safety conduit system where, if only one component fails, the whole system does not need to be replaced. Thus, a safety conduit system with interchangeable components would provide economic benefit to the end user.

Lefere et al. (US 20040032124) is directed to a two-layer textile reinforced hose consisting of a tube or conduit, a reinforcement layer over this tube or conduit, another layer over this first reinforcement layer, an additional reinforcement layer, and a cover over this additional reinforcement layer. Thus, there may be a polymeric inner tube and at least one braided or spiral wound reinforcement layer.

### OBJECTS AND SUMMARY OF THE INVENTION

It is an object of at least one embodiment of the present invention to provide a safety conduit system for a fluid delivery handling system and particularly to a coupling configured to withstand high-pressure fluids.

It is another object of the at least one embodiment of the present invention to provide a coupling through which fluids at high pressure, such as pressures above 10,000 psi flow.

It is another object of at least one embodiment of the present invention to provide a coupling configured to have a higher failure pressure than a hose with which the coupling is connected.

In order to achieve one or more of these objects or possibly others, a coupling in accordance with the invention includes an elongate housing, at least one barb at one end of the housing to define a barbed end of the housing, and first, second and third trapezoid teeth at an opposite end of the housing from the barbed end to define a toothed end of the housing. The first, second and third teeth are spaced apart from one another by grooves, and may be, but are not required to be, the only teeth on the toothed end of the housing. The teeth are optimally configured to enable coupling with a conduit while avoiding separation of the conduit with the toothed end of the housing at a pressure of about 40,000 psi.

In one embodiment, instead of or in addition to the three trapezoidal teeth, there is a thread on an outer surface of the housing rearward of the barb closest to the toothed end of the housing in a direction toward the toothed end of the housing, This thread is situated farther from a central axis of the housing than the barb(s). In use, a ferrule of a conduit connecting to the barbed end includes a complementary thread on an inner surface to enable threading engagement of the ferrule to the thread of the housing. The housing can include a tubular part on which the thread is situated.

The housing has a conduit in the barbed end and a conduit in the toothed end. The conduit in the barbed end is smaller than the conduit in the toothed end. The housing includes a transition region with a variable diameter coupling the conduit in the barbed end and the conduit in the toothed end.

Another embodiment of a coupling in accordance with the invention includes an elongate housing, at least one barb at one end of the housing to define a barbed end of the housing, a plurality of spaced apart teeth at an opposite end of the housing from the barbed end to define a toothed end of the housing, and a thread on an outer surface of the housing rearward of the barb closest to the toothed end of the housing in a direction toward the toothed end of the housing. The thread is situated farther from a central axis of the housing than the barb(s). A ferrule of a conduit connecting to the barbed end includes a complementary thread on an inner surface to enable threading engagement of the ferrule to the thread of the housing.

A safety conduit system in accordance with the invention includes a pair of any of the couplings described above and a conduit including only a thermoplastic hose, and stainless steel reinforcement around the hose. There is only a single layer of thermoplastic in such a conduit, inward of the reinforcement layer. A coupling is attached to each end of the conduit via the barbed end thereof. When the conduit includes a threaded ferrule at each end, the ferrules connect to the threads on the barbed end to enable threading engagement of the ferrules to the threads of the housing.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

Non-limiting examples of embodiments of the invention are described below with reference to figures attached hereto that are listed following this paragraph. Identical features that appear in more than one figure are generally labeled with the same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1 shows a partial view of the safety conduit system in accordance with the invention before attachment of the fitting to the conduit.

FIG. 2 shows a partial view of the safety conduit system in accordance with the invention with an embodiment of the fitting before attachment to the conduit.

FIG. 3 is a cut away partial view of a fitting in accordance with the invention.

FIG. 4 is a cut away partial view of a safety conduit system in accordance with the invention.

FIG. 5 is a partial view, according to some embodiments, of the safety conduit system with different external positioning devices in accordance with the invention.

FIG. 6 is a partial view, according to some embodiments, of the safety conduit system with an elbow conduit element in accordance with the invention.

FIG. 7 is a prospective view of a complete safety conduit system in some embodiments in accordance with the invention.

FIG. 8 is a side plain view of a fitting in accordance with the invention.

FIG. 9 is a perspective view of another embodiment of a coupling for a safety conduit system in accordance with the invention.

FIG. 10 is a cross-sectional view of the coupling shown in FIG. 9.

A better understanding of the disclosed technology will be obtained from the following detailed description of the preferred embodiments, taken in conjunction with the drawings and the attached claims.

### DETAILED DESCRIPTION OF THE INVENTION

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins.

In the description and claims of the present application, each of the verbs, “comprise”, “include” and “have”, and conjugates thereof, are used to indicate that the object or objects of the verb are not necessarily a complete listing of components, elements or parts of the subject or subjects of the verb.

The terms “conduit” or “hose” as used herein are interchangeable in meaning.

To aid in describing the disclosed technology, directional terms may be used in the specification and claims to describe portions of the present technology (e.g., upper, lower, left, right, etc.). These directional definitions are merely intended to assist in describing and claiming the disclosed technology and are not intended to limit the disclosed technology in any way. In addition, reference numerals that are introduced in the specification in association with a drawing figure may be repeated in one or more subsequent figures without additional description in the specification, in order to provide context for other features.

With reference now to the drawings, a device is shown for a safety conduit system for fluid.

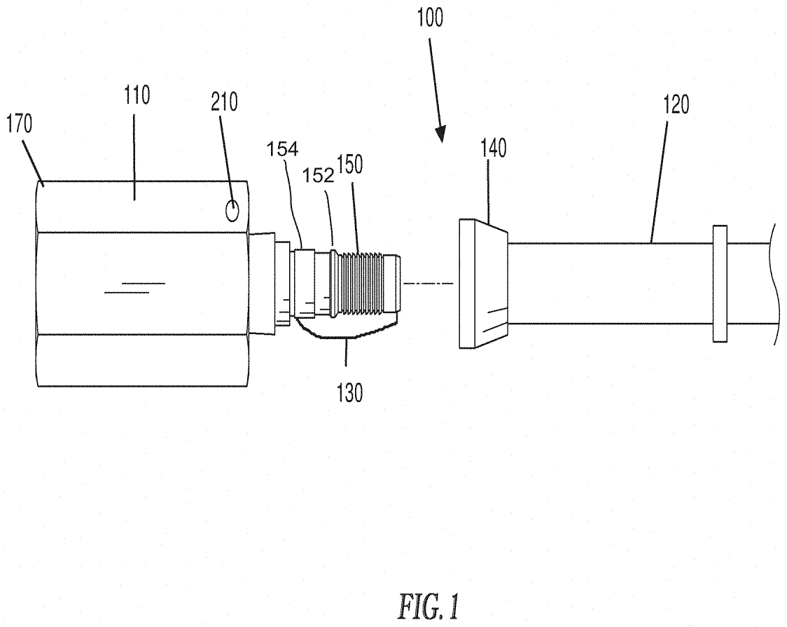

Referring to FIG. 1, reference number 100 refers generally to a safety conduit system. Fixture or fitting 110 is configured to connect high-pressure conduit 120 to elements, hoses and conduits of a handling system. The handling system is typically used for movement of gases and/or liquids. In an embodiment, there is a second end of the high-pressure conduit 120 having a second fitting 110, also for connecting to other elements in the handling system.

Optionally, high-pressure conduit 120 is made from ETFE and handles burst pressures of fluids travelling though of about 12,000-psi to 40,000-psi. ETFE, specifically, polyethylene-co-tetraflouroethylene is an ultra high pressure smoothbore EFTE (Ethylene tetrafluoroethylene). ETFE is a fluorine-based plastic. It was designed to have high corrosion resistance and strength over a wide temperature range. ETFE is a polymer and its source-based name is poly(ethene-co-tetrafluoroethene). ETFE has a relatively high melting temperature, excellent chemical, electrical and high-energy radiation resistance properties. More specifically, the conduit may have properties of an ETFE of 6,000 psi working pressure and 24,000 psi burst pressure. In some embodiments, the high-pressure conduit 120 is a general conduit handling substances less than 24000 psi. Conduit 120 optionally may have a high flexibility.

In an embodiment the fitting 110 has two ends, one end having a tapered section 130. The tapered section 130 is used for connection to conduit 120. Tapered section 130 is placed into an end of conduit 120 and optionally crimp 140 secures tapered end 130 of fitting 110 inside a circumference of conduit 120. Crimp 140 optionally is longer than a crimp well known in the art of about 1-10 centimeter or more.

Although fitting 110 is shown with tapered end 130 fitting into conduit 120, optionally, fitting 110 is wider in diameter than conduit 120 such that conduit 120 is connected inside circumference of the fitting 110. When using the ETFE conduit 120, one option is to use barbed teeth 150 on tapered section 130. The barbed teeth 150 have one-way sharpness so that the tapered end 130 easily fits into the end and inside the circumference of conduit 120. Therefore, barbed teeth 150 cause excessive friction when trying to remove fitting 110 from conduit 120 increasing the strength of the attachment. Optionally, barbed teeth 150 would be comprised of 5 or more rows to further strengthen the attachment.

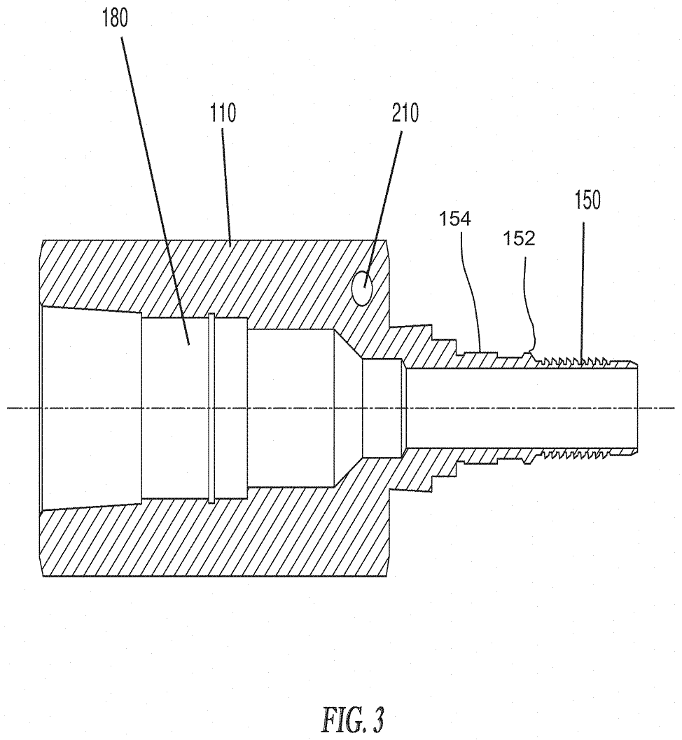

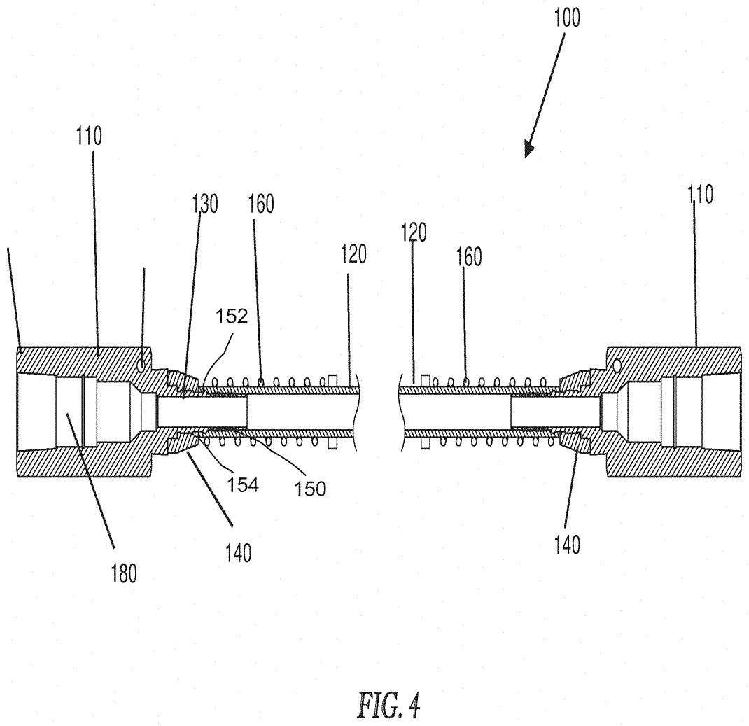

As seen in FIG. 1, there are different shapes of barbs, in addition to the barbed teeth 150, the different shapes being seen in cross-section. There is an additional circumferential barb 152 axially spaced apart rearward of barbed teeth 150 from the forward end of the tapered section 130 which, as seen better in FIGS. 3 and 4, extends more radially outward from the center axis of the tapered section than barbed teeth 150. Barb 150 has a trapezoidal cross-sectional shape, with an upward and rearwardly angled front surface a flat upper surface and a downward and rearwardly angled rear surface. There is also circumferential barb 154 axially spaced apart rearward of barb 152 which, as seen better in FIGS. 3 and 4, extends more radially outward from the center axis of the tapered section than barbed teeth 150. Barb 154 has a rectangular cross-sectional shape, with flat front and rear surfaces and a flat upper surface. As shown in FIG. 4, the barbed teeth 150 and barbs 152, 154 will all be covered by the conduit 120 and the crimp 140 thereon.

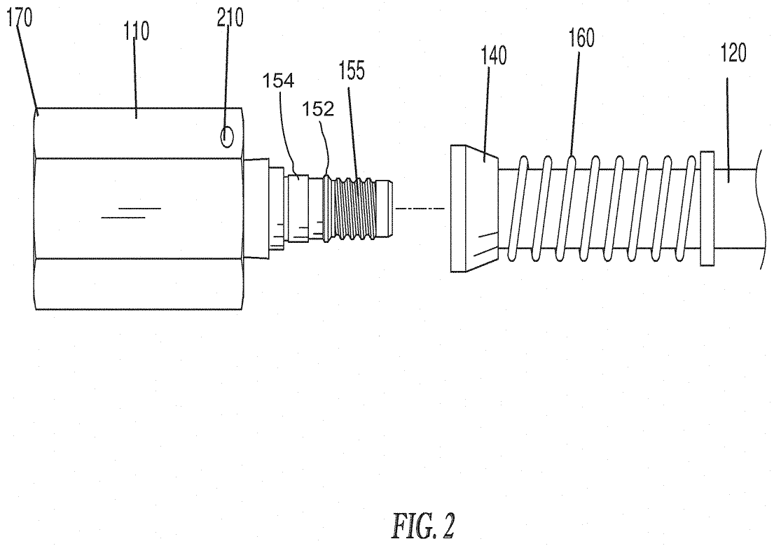

FIG. 2 illustrates a similar configuration of the safety conduit system 100 of FIG. 1 with two additional options. Bend restrictor 160 around conduit 120 is used to reduce the flexibility of conduit 120 at the attachment point adjacent to fitting 110. Tapered end 130 has screw threads 155, which is another option for a stable attachment of fitting 110 to conduit 120. These screw threads 155 optionally are in addition to barbed teeth 150. Screw threads 155 are used with mating screw threads on the inside of conduit 120 (not shown).

Fitting tapered end 130 again may have a non-tapered wider circumference than the conduit 120 and have screw threads on its inner circumference which connect to the outer circumference of the conduit 120 having mating screw threads. Further, the opposite end 170 of fitting 110 also may have screw threads, inside and/or outside the circumference for mating with screw threads on one of the elements of the handling system. This screw thread system is useful to replace individual parts of the safety system 100. As a result, the entire safety conduit system 100 does not need to be replaced when failure and/or wearing down of parts occurs.

FIG. 3, by way of example, schematically illustrates inner diameters 180 of fitting 110 configured to accept a valve system (not shown). A valve system used for changing a valve body and/or valve seat position, which closes or connects the valve body and valve seat at failure of the safety conduit system 100 creates a closed valve Any well-known means in the art for changing valve body positions and/or valve seats consistent with the current disclosure may be used.

By way of example, when a valve body is at rest, where valve body tends toward a closed position, but is maintained by a non-ferrous cable or rod, tube or spring in an open position on the walls of the fitting, until safety system conduit 100 fails. Upon failure of safety conduit system 100, the spring fails and valve bodies move to the preferred rest position, connecting with the valve seat resulting in valve closure. A second example is when a valve body is at rest, where valve body tends toward an open position, but is maintained by a rod in a closed position on the walls of the fitting, until safety system conduit 100 fails. Upon failure of safety conduit system 100, the rod pulls valve bodies to a closed position, connecting with the valve seat resulting in valve closure. When valve body and valve seats are in a closed valve position the combination prevents leakage or spillage of the fluids contained within the system.

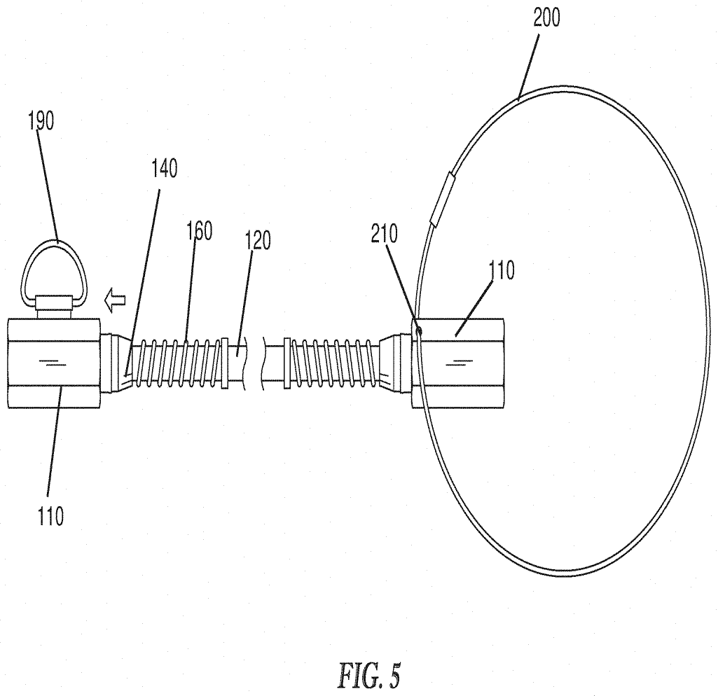

FIG. 4 is an example of the safety conduit system 100 with a cut away of the middle of the conduit 120. FIG. 5 shows an example of a handle 190 especially advantageous when the fittings 110 and conduits 120 have diameters of more than about 10 inches.

Any size fitting 110 may have an aperture 210 to accommodate safety loop 200. Safety loop 200 is configured to wrap or hang around other elements of a handling system, and is advantageous for keeping the safety conduit system 100 in place on the handling system. The safety loop is especially helpful with smaller diameter fittings 110 and conduits 120

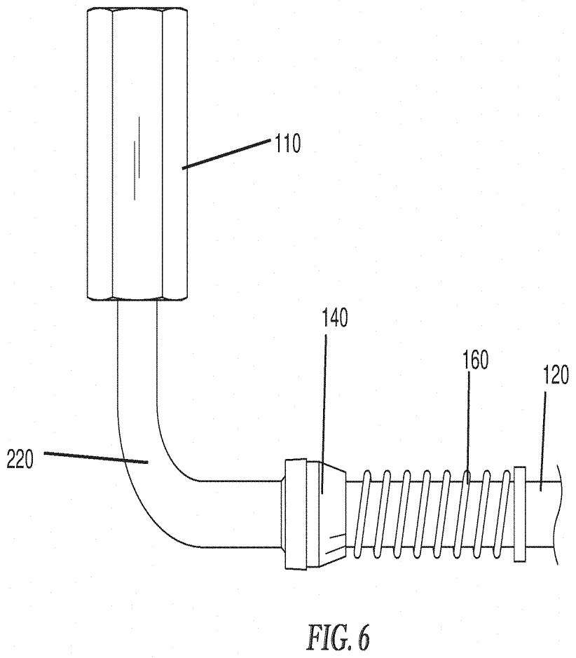

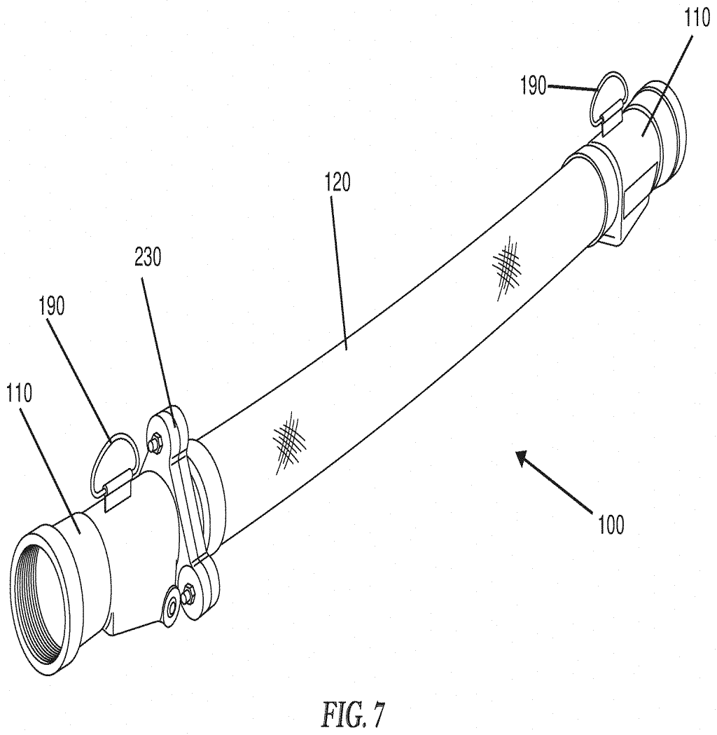

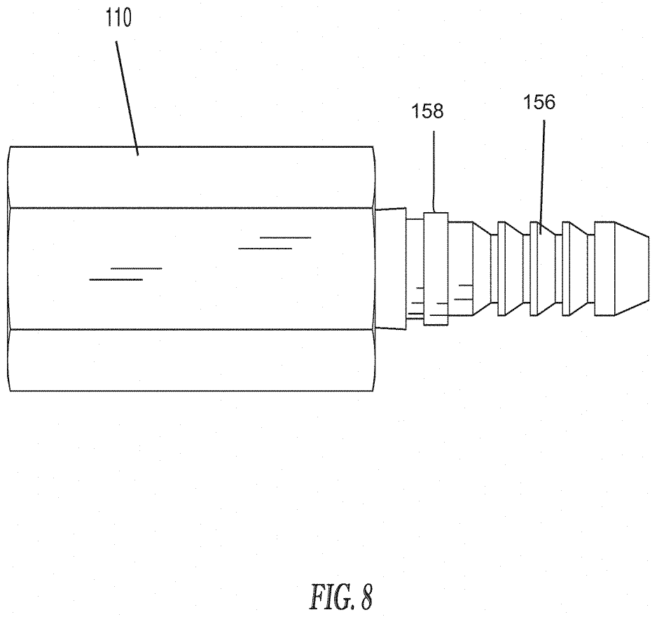

FIG. 6 illustrates an elbow connection 220 between fitting 110 and conduit 120. Elbow connection 220 is advantageous in a tight configuration of the handling system such that a bend at elbow connection 220 would allow adequate exposure of fitting 110. FIG. 7, by way of example, is a larger version of safety conduit system 100 also having a seam 230 for bolts and/or pins to allow safety conduit system 100 to break away in the event of a system failure. FIG. 8 is a side view of a fitting 110 showing an embodiment of barbed teeth 150. As seen in FIG. 8, there is a set of barbed teeth 156 and an additional barb 158 axially spaced apart rearward from the barbed teeth 156, and which additional barb 158 has a different cross-sectional shape than barbed teeth 156, i.e., a rectangular cross-sectional shape.

Aspects of the foregoing disclosed technology, according to some embodiments thereof, relate to providing a safety conduit system comprising a conduit having a first and second end and a fitting at each end of the conduit defining a valve seat. Further, valve bodies in each fitting are configured to connect to a valve seat, at the time of failure of a conduit, resulting in valve closure.

One objective of one or more embodiments of the foregoing disclosed invention(s) is to have a safety conduit system, as part of a handling system of conduits and additional elements needed in the handling system. The safety conduit system is for a high-pressure conduit that can withstand pressure in excess of approximately 24,000 psi. Further, a unique fitting of the safety conduit system is configured to attach the fitting to the high-pressure conduit. Optionally, fitting features are configured for further customizable replacements when needed in the safety conduit system.

Another objective of one or more embodiments of the foregoing disclosed invention(s) is to have a safety system where the components include a safety fitting, an elbow, conduit and an additional safety fitting thereby protecting the entire assembly in case of a failure.

In a further objective of one or more embodiments of the foregoing disclosed invention(s), the ability to lift and carry a safety hose can be facilitated by the inclusion of handles integrated to each fitting.

In yet another embodiment of one or more embodiments of the foregoing disclosed safety conduit system, the conduit has first and second ends and inner and outer surfaces, with the conduit configured to withstand pressures exceeding 24,000 psi and a fitting at each end of the conduit defining a valve seat configured to accept a valve body to define a closed valve. Also, a means for keeping valve bodies and seats at an open position until conduit failure and means for movement of the valve body to meet valve seat to close a valve upon conduit fails, wherein the fitting further comprises a tapered barbed segment on one end configured to fit into and connect the fitting to an inner portion on either end of the conduit

In the safety system described above and those described below, the material for the conduit may be Polyethylene-co-tetraflouroethylene (PTFE) or Ethylene Tetraflouroethylene (ETFE). Also, the material for the conduit can withstand a burst pressure of between about 12,000 to 40,000 psi. The fitting of the safety system comprises a tapered segment on one end and an opposite end having means to removably attach to a handling system of conduits, and tapered section has a plurality barbed teeth configured to be placed inside conduit and prevent removal of the fitting from the conduit.

In the above-described safety system, there is the plurality of barbed teeth which may comprise 5 or more barbed teeth, and the conduit further comprises a tubular core having inner and outer surfaces and further configured to have a plurality of tubular layers surrounding the outer surface of the tubular core; and an outer containment sleeve having an inner and outer surface, the inner surface of the outer containment sleeve surrounding the outer surface of the plurality of tubular layers. The safety system also comprises and elbow connection configured to connect the conduit to the fitting.

In an embodiment of the safety conduit system described above, an aperture on the fitting is configured to receive a safety loop connected to the fitting, and/or comprising a handle configured to attach to the fitting. The tapered end of the fitting has means to removably attach to the conduit of the safety conduit system, and the fittings and the conduits are removably attached at each respective ends, such that the system has interchangeable components. The means to removably attach are mating screw threads. The safety system for conduits includes a crimp configured to secure attachment of the fitting to the conduit, wherein the crimp is of at least 1-10 centimeters in length on the end of the conduit.

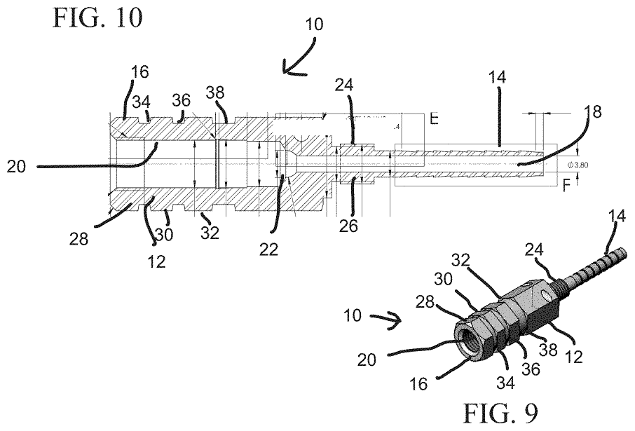

Referring now to FIGS. 9 and 10, another embodiment of a coupling 10 in accordance with the invention is shown. Coupling 10 includes a housing 12 having a barbed end 14 and a toothed end 16, each of which is connected to a conduit or hose or similar component for use. The conduit to which the barbed end 14 is connected is preferably a single layer hose reinforced with a non-textile material, such as stainless steel. Housing 12 may be unitary, i.e., formed as one-piece. The single layer hose may be made of thermoplastic, and includes only this single layer and no other thermoplastic layer. The preferred hose thus includes only the single layer of thermoplastic and the reinforcement layer, which is optimally stainless steel, which would provide the outermost surface of the hose.

A safety conduit system in accordance with the invention would include a pair of couplings 10, and a stainless-steel reinforced PTFE hose connecting the barbed ends 14 of the two couplings 10. Such a hose has a polymeric inner tube and stainless steel reinforcement on the outside, which construction enables flow of fluid through the safety conduit system at pressures exceeding 10,000 psi and even as high as 24,000 psi. The hose has a ferrule on each end that connects to the housing 12 of the respective coupling 10. Such a hose may be like high pressure conduit 120 described above.

Barbed end 14 has a smaller diameter than toothed end 16, and the conduit 18 in the barbed end 14 has a smaller diameter than the conduit 20 in the toothed end 16. An inner conduit transition region 22 is provided in a central area of the housing 12 to provide a transition for flow of fluid between the smaller diameter conduit 18 in the barbed end 14 and the larger diameter conduit 20 in the toothed end 16. Inner conduit transition region 22 has a variable diameter.

There are a plurality of barbs 22 at barbed end 14, which may all have the same configuration and preferably extend uniformly around the circumference of an outer surface of the housing, i.e., are circumferentially extending. These barbs 22 are formed on or integral with the outer surface of the housing 12. The shape, location and number of the barbs 22 may be as determined to be necessary to secure attachment of, for example, a single layer metal-reinforced hose.

Rearward of the barbs 22, i.e., closer to the center of the housing 12, is a thread 24 formed on an outer surface of a tubular part 26 of the housing 12. The outer thread 24 extends farther from the central axis of the housing 12 than the barbs 22 to enable a mating ferrule with an inner thread to engage with and be threaded to the housing 12 to thereby form a threaded engagement of the conduit to which the ferrule is attached and the coupling 10. For engagement, the conduit is rotated in one direction once the outer and inner threads are engaged until further rotation is no longer possible. This thread 24 is optional for this embodiment, and a coupling 10 in accordance with the invention may include only the remaining structure as described herein.

The dimensions of the outer thread 24, and the corresponding dimensions of the inner thread on the ferrule (not shown) can be determined by those skilled in the art to which this invention pertains without undue experimentation. Through testing, the dimensions can be determined to avoid separation at the location of the thread 24 prior to failure of the conduit to which the ferrule is attached.

The addition of an outer thread to a coupling, and specifically onto the fitting itself, can be incorporated into a coupling other than those disclosed herein. In a general adaptation, an outer thread is integrated into the housing of the coupling between the barbed region (which contains one or more barbs) that will connect to the hose or conduit and a remaining part of the housing, i.e., what is being considered rearward of the barbs from the operative edge of the barbed end that is inserted into the conduit. The outer thread is elevated from the barbs, i.e., distanced farther from the central axis of the conduit passing through the barbed end of the coupling. Otherwise, the ferrule on the conduit with an inner thread would not be able to pass over the barbs to engage with the outer thread, and be rotated relative to the coupling to engage the ferrule of the conduit with the coupling. By providing the thread on the ferrule itself, instead of crimping the ferrule as in conventional safety conduit system, significant advantages are obtained, such as improved conduit retention. In prior art safety conduit systems, the ferrule does not thread onto the fitting but rather is attached to the fitting shoulder, e.g., by crimping. This aspect of the invention therefore eliminates this attachment and substitutes a rotational threading engagement, which is more secure and less likely to result in separation of the conduit from the fitting.

The toothed end 16 of the housing 12 includes three separated teeth 28, 30, 32 that have portions projecting upward from the housing 12, and whose relative position and shape are selected to achieve specific advantages. Teeth 28, 30, 32 preferably extend uniformly (each in their respective shape) around the circumference of an outer surface of the housing, i.e., are circumferentially extending. Although the described relative position and shape of the teeth 28, 30, 32 is not absolutely required, it has been found that there is a certain degree of criticality to these dimensions to enable a hose connected to the toothed end 16 of the coupling 10 to withstand 10,000 psi pressure and not separate.

The specific dimensions of the teeth 28, 30, 32 are that there is a distance D1 of about 8.04 mm between the rear edge of the toothed end 16 and the center of a groove 34 between teeth 28 and 30, and a distance D2 of about 8.04 mm between the center of the groove 34 between teeth 28 and 30 and the center of a groove 36 between teeth 30 and 32. Thus, the distances D1, D2 between the edge of the toothed end 16 and the center of the groove 34 between teeth 28 and 30, and between the center of the groove 34 between teeth 28 and 30 and the center of the groove 36 between teeth 30 and 32, respectively, should be the same. This distance of about 8.04 mm can vary by about 5% without significantly impacting the ability of the coupling 10 to maintain connection with a hose at the toothed end 16.

The distance D3 between the center of the groove 36 between teeth 30 and 32 and between the center of a groove 38 between tooth 32 and a remaining part of the housing 12 is about 10.59 mm, i.e., larger than the distances D1 and D2. Again, although these exact dimensions are not required, they offer optimal retention conditions for a hose connected to the toothed end 16, and therefore may be considered critical in one or more embodiments of the coupling 10 disclosed herein, i.e., when relatively high pressure hoses are sought.

Another important dimension is the size of the grooves 34, 36, 38. Grooves 34, 36 should be about ½ the size of the groove 38, when measuring their distances at the bottom of each groove. The distance of the teeth 28, 30, 32 and grooves 34, 36, 38 is that dimension in the axial or longitudinal direction of the housing 12.

An angle of opening of each groove 34, 36, 38 may be about 20 degrees. The angle of opening is the angle between a radial plane passing through the corner of a side wall of a tooth defining the groove and the side wall of the groove which tapers away from the groove. The radial plane is the plane perpendicular to the central axis. As such, the cross-section shape of each tooth 28, 30, 32, when viewed in cross-section as seen in FIG. 10, is a trapezoid, considering the base to be that side of each tooth 28, 30, 32 that is contiguous with the housing 12. The three trapezoid teeth 28, 30, 32 are believed to be instrument in providing improved retention for a mating hose on the barbed end 14, relative to prior art couplings.

The rear edge of the tooth 28 may be provided with a chamfer of, for example, 45 degrees. The same chamfer may be provided to the edge of the housing 12 alongside the entrance to the conduit 18.

The diameter of the housing 12 at the toothed end is about 19.05 mm, measured to the bottom of the grooves 34, 36, 38. The outer shape of the teeth 28, 30, 32 is selected to enable the toothed end 16 of the coupling 10 to mate with existing hoses with receptacles for receiving couplings in the fluid conveyance field.

It is contemplated that the dimensions of coupling 10 can be scaled upward or downward while still enabling the improved hose retention of the toothed end 16 of the coupling 10. Thus, the specific shape and dimensions of the teeth 28, 30, 32 are simply preferred as they have been found to provide optimal retention. Other combinations of shapes and dimensions are not precluded, but the specific shape and dimensions is preferred, and in some embodiments when high pressure fluids are used, may be critical to operability.

An important objective of the invention is to avoid separation of a hose from the toothed end 16 in a high-pressure application before the hose breaks. This objective is achieved at least by the coupling 10 with the specific shape and dimensions. Indeed, it believed that the coupling 10, with the exact configuration shown and described herein including the specific dimensions, can maintain its connection to a thermoplastic hose with stainless steel reinforcement at a level of about 40,000 psi. This is believed to be a higher pressure than prior art couplings, fittings and fixtures, which may endure separation of the coupling from the hose at such a high pressure.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A coupling, comprising:
an elongate housing;
at least one barb at one end of said housing to define a barbed end of said housing; and
first, second and third trapezoid teeth at an opposite end of said housing from said barbed end to define a toothed end of said housing, said first, second and third teeth being spaced apart from one another.

2. The coupling of claim 1, further comprising a thread on an outer surface of said housing rearward of one of said at least one barb closest to said toothed end of said housing in a direction toward said toothed end of said housing, said thread being situated farther from a central axis of said housing than said at least one barb, whereby a ferrule of a conduit connecting to said barbed end includes a complementary thread on an inner surface to enable threading engagement of said ferrule to said thread of said housing.

3. The coupling of claim 2, wherein said housing further includes a tubular part on which said thread is situated.

4. The coupling of claim 1, wherein said housing has a conduit in said barbed end and a conduit in said toothed end, said conduit in said barbed end being smaller than said conduit in said toothed end, said housing including a transition region with a variable diameter coupling said conduit in said barbed end and said conduit in said toothed end.

5. The coupling of claim 1, wherein said at least one barb comprises a plurality of identical, circumferentially extending barbs.

6. The coupling of claim 1, wherein said first tooth is closest to an edge of said housing at said toothed end, said second tooth is inward of said first tooth and said third tooth is closest to said barbed end, said first, second and third teeth being the only teeth on said toothed end of said housing and extending circumferentially around said housing.

7. The coupling of claim 6, wherein said first and second teeth are spaced apart a distance in an axial direction of said housing of about 2.54 mm, and said second and third teeth are spaced apart a distance in an axial direction of said housing of about 2.54 mm.

8. The coupling of claim 7, wherein said third tooth is spaced apart a distance in an axial direction of said housing of about 5.08 mm from a remaining part of said housing.

9. The coupling of claim 6, wherein said first and second teeth are spaced apart a set distance, said second and third teeth are spaced apart the same distance as between said first and second teeth, and said third tooth is spaced apart a distance from a remaining part of said housing that is twice the distance that said first and second teeth are spaced apart.

10. The coupling of claim 6, wherein said housing includes a first groove between said first and second teeth, a second groove between said second and third teeth and a third groove between said third tooth and a remaining part of said housing, a distance in an axial direction of said housing between the edge of said housing at said toothed end and a center of said first groove being equal to a distance in an axial direction of said housing between the center of said first groove and the center of said second groove.

11. The coupling of claim 10, wherein the distance in the axial direction of said housing between the edge of said housing at said toothed end and the center of said first groove and the distance in the axial direction of said housing between the center of said first groove and the center of said second groove is about 8.04 mm.

12. The coupling of claim 10, wherein the distance in the axial direction of said housing between the center of said second groove and the center of said third groove is greater than the distance in the axial direction of said housing between the center of said first groove and the center of said second groove.

13. The coupling of claim 10, wherein an angle of opening of each of said first, second and third grooves is about 20 degrees.

14. The coupling of claim 1, wherein said teeth are configured to enable coupling with a conduit while avoiding separation of the conduit with said toothed end of said housing at a pressure of about 40,000 psi.

15. A coupling, comprising:
an elongate housing;
at least one barb at one end of said housing to define a barbed end of said housing;
a plurality of teeth at an opposite end of said housing from said barbed end to define a toothed end of said housing, said plurality of teeth being spaced apart from one another; and
a thread on an outer surface of said housing rearward of one of said at least one barb closest to said toothed end of said housing in a direction toward said toothed end of said housing, said thread being situated farther from a central axis of said housing than said at least one barb,
whereby a ferrule of a conduit connecting to said barbed end includes a complementary thread on an inner surface to enable threading engagement of said ferrule to said thread of said housing.

16. A safety conduit system, comprising:
a conduit comprising a thermoplastic hose, and stainless steel reinforcement around said hose; and
a pair of couplings, one at each end of said conduit, each of said couplings comprising:
an elongate housing;
at least one barb at one end of said housing to define a barbed end of said housing, ends of said conduit being connected to said barbed end of said couplings; and
first, second and third trapezoid teeth at an opposite end of said housing from said barbed end to define a toothed end of said housing, said first, second and third teeth being spaced apart from one another.

17. The safety conduit system of claim 16, wherein said conduit further comprises a ferrule at each end, each of said ferrules including an inner thread, each of said couplings further comprising a thread on an outer surface of said housing rearward of one of said at least one barb closest to said toothed end of said housing in a direction toward said toothed end of said housing, said thread being situated farther from a central axis of said housing than said at least one barb, said ferrules of said conduit connecting to said barbed end to enable threading engagement of said ferrules to said threads of said housing.

18. The safety conduit system of claim 16, wherein said first tooth is closest to an edge of said housing at said toothed end, said second tooth is inward of said first tooth and said third tooth is closest to said barbed end, said first, second and third teeth being the only teeth on said toothed end of said housing.

19. The safety conduit system of claim 18, wherein said first and second teeth are spaced apart a set distance, said second and third teeth are spaced apart the same distance as between said first and second teeth, and said third tooth is spaced apart a distance from a remaining part of said housing that is twice the distance that said first and second teeth are spaced apart.

20. The safety conduit system of claim 18, wherein said housing includes a first groove between said first and second teeth, a second groove between said second and third teeth and a third groove between said third tooth and a remaining part of said housing, a distance in an axial direction of said housing between the edge of said housing at said toothed end and a center of said first groove being equal to a distance in an axial direction of said housing between the center of said first groove and the center of said second groove, the distance in the axial direction of said housing between the center of said second groove and the center of said third groove is greater than the distance in the axial direction of said housing between the center of said first groove and the center of said second groove, and an angle of opening of each of said first, second and third grooves is about 20 degrees.
